(19) United States
(12) Patent Application Publication
(10) Pub. No.: US 2023/0127399 A1
(43) Pub. Date: Apr. 27, 2023

(54) System and Method of Monitoring Adiabatic Cooling Media

(71) Applicant: Ecolab USA Inc., St.Paul, MN (US)

(72) Inventors: Zhangzhang Yin, Aurora, IL (US); Robert M. Lowe, Chicago, IL (US); Shawn Michael Dalke, Sugar Grove, IL (US); Michael J. Murcia, Sycamore, IL (US); Joshua Michael Minney, Rancho Santa Margarita, CA (US); Michael J. Lesniak, Colbert, WA (US); Matthew McMullen, Seattle, WA (US)

(73) Assignee: Ecolab USA Inc., St. Paul, MN (US)

(21) Appl. No.: 17/973,334

(22) Filed: Oct. 25, 2022

Related U.S. Application Data
(60) Provisional application No. 63/271,536, filed on Oct. 25, 2021.

(51) Int. Cl. F25B 49/00; F25B 19/00; H05K 7/20

(52) U.S. Cl. CPC F25B 49/00; F25B 19/00; H05K 7/20136; H05K 7/20272; H05K 7/2079

(57) ABSTRACT

The disclosed systems and method for evaluating the integrity of media pads within an adiabatic cooling system includes at least one media compartment containing at least one media coupon that is representative of at least one of the media pads. The system is adapted to be fluidly coupled to a source of representative process water and to provide such water to the at least one media compartment. A source of airflow fluidly is also coupled to the at least one media compartment. The flow of representative process water and airflow to the media coupon within the media compartment simulates the operation of the adiabatic cooling system. The at least one media coupon may then be analyzed as representative of media pads within the adiabatic cooling system.

### CROSS-REFERENCE TO RELATED APPLICATIONS

This application claims priority to U.S. Provisional Patent Application No. 63/271,536, filed Oct. 25, 2021, which is incorporated by reference herein in its entirety for all purposes.

### TECHNICAL FIELD

This patent disclosure relates generally to adiabatic cooling systems, and, more particularly, the invention pertains to monitoring the media utilized in adiabatic cooling systems.

### BACKGROUND

Data centers generate significant heat, which can affect not only the efficiency, but the very operation, of data centers. Adiabatic (or evaporative) cooling systems provide an effective way to remove the significant heat load generated by a data center. Evaporative cooling system generally draw heated air through water-moistened pads. A hyperscale facility can have dozens of data halls and each data hall can have dozens of adiabatic cooling units that contain several adiabatic media pads. As water evaporates from the pads, the surrounding air is cooled. The cooled air is pushed or drawn out of the adiabatic cooling system to the warmer environment.

Adiabatic cooling is typically seasonal and based on the temperature requirements. Units are generally shut down once a day and allowed to dry out.

These cooling systems can be inefficient and unreliable without proper water treatment and proper maintenance of adiabatic media pads. This can result in poor operation, damage/collapse of the adiabatic media, heightened legionella risk, and the possibility of unplanned downtime. The industry exhibits little to no understanding, however, as to how to safely and effectively treat such systems or the evaporative fluid. The only way to inspect the media is visually or by measurement of performance criteria, such as pressure, temperature, and humidity. These measurements may not be indicative of the media's strength, integrity, or remaining life span, however. There is no way to take a sample of the media without removing part of a pad that is in use. This can disrupt the operation of the unit and degrade operational efficiency. Currently, there is not a way to accelerate the mechanisms of media aging so that integrity issues can be anticipated and addressed.

### SUMMARY

The disclosure describes, in one aspect, a system for evaluating the integrity of media pads within an adiabatic cooling system including process water within a circulation system. The system for evaluating includes at least one media compartment, and at least one media coupon disposed within the media compartment, the media coupon being representative of at least one of the media pads within the adiabatic cooling system. At least a first conduit is adapted to be fluidly coupled to a source of representative process water, the representative process water being representative of process water within the circulation system. The first conduit is fluidly coupled to provide the representative process water to the at least one media compartment. A source of airflow fluidly is also coupled to the at least one media compartment. A flow of representative process water and an airflow are provided to the at least one media compartment to simulate the adiabatic cooling system. The at least one media coupon may then be analyzed as representative of media pads within the adiabatic cooling system.

The disclosure describes, in another aspect, a method of evaluating the integrity of media pads within an adiabatic cooling system including process water within a circulation system. The method includes providing a flow of representative process water from the adiabatic cooling system through at least a first conduit system to at least one media compartment containing at least one media coupon to simulate the flow of process water to media pads within the adiabatic cooling system, the at least one media coupon being representative of at least one of the media pads within the adiabatic cooling system; providing a flow of air to the at least one media compartment to simulate the flow of air to media pads within the adiabatic cooling system; removing the at least one media coupon; and analyzing the at least one media coupon as representative of media pads within the adiabatic cooling system.

In at least one embodiment, the method includes providing the flow of representative process water to saturate the at least one media coupon, and providing the flow of air to the at least one media compartment to dry out the at least one media coupon. The saturation and drying out of the at least one media coupon simulates a specified period of time of operation of the adiabatic cooling system. In at least one embodiment, the method further includes repeating the simulation of the specified period of time of operation of the adiabatic cooling system at least once.

In at least one embodiment, the method includes providing flow of representative process water and a flow or air in a manner and schedule similar to the adiabatic cooling system.

### BRIEF DESCRIPTION OF THE DRAWING(S)

FIG. 1 schematically illustrates an exemplary adiabatic cooling system and a system for monitoring adiabatic cooling media according to teachings of this disclosure;

FIG. 2 schematically illustrates an exemplary system for monitoring adiabatic cooling media according to teachings of this disclosure;

FIG. 3 is an isometric view of the rear and side of an alternate exemplary embodiment of a system for monitoring adiabatic cooling media according to teachings of this disclosure;

FIG. 4 is an isometric view of the front and opposite and side of the embodiment of FIG. 3.

### DETAILED DESCRIPTION

Further, for purposes of this disclosure, the following terms have the definitions set forth below:

“Adiabatic cooling system” means any evaporative system wherein air flows across and/or through water-moistened media pads to provide air at a cooler temperature. As water evaporates from the pads, the surrounding air is cooled. The cooled air is pushed or drawn out of the adiabatic cooling system to the warmer environment

“Water” means any substance that has water as a primary ingredient. Water may include pure water, tap water, fresh water, steam, and/or any chemical, solution, or blend that is circulated in an adiabatic cooling system.

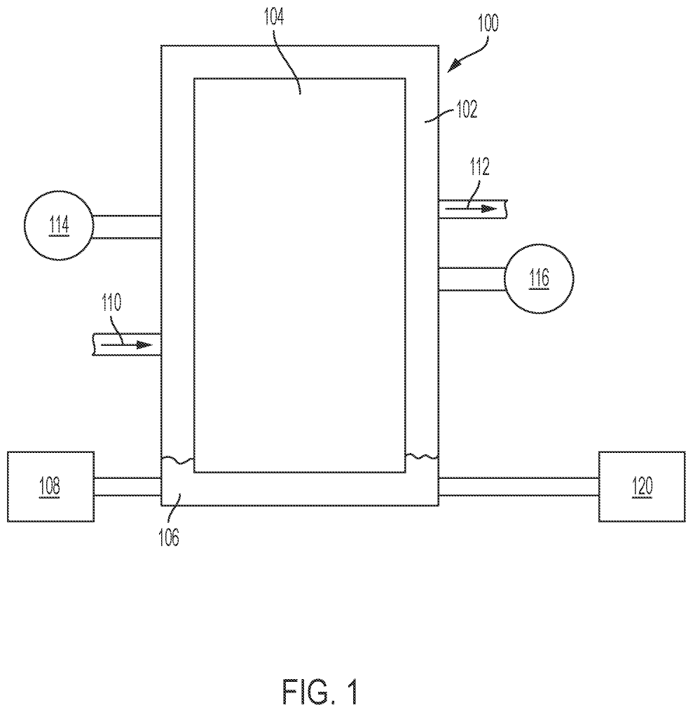

This disclosure is directed to system for testing and methods for evaluating media utilized in adiabatic cooling systems by simulating aging of such samples. Turning to FIG. 1 there is illustrated a schematic view of an exemplary adiabatic cooling system 100. While the details are the exemplary adiabatic cooling system 100 are not illustrated in detail, those of skill in the art will appreciate that such an adiabatic cooling system 100 may include a plurality of chambers 102, only one of which is illustrated. The chamber 102 may include at least one adiabatic media pad 104, which is disposed to provide saturation from a source of process water 106 from a circulation system (indicated generally as 108). Warm dry air 110 is directed to the adiabatic media pad 104, and cold, humid air 112 flows from the adiabatic media pad 104 as water evaporates from the adiabatic media pad 104. Airflow may be provided by a fan 114 or the like that pushes air through the adiabatic media pad 104, and/or a fan 116 or the like that draws air through the adiabatic media pad 104.

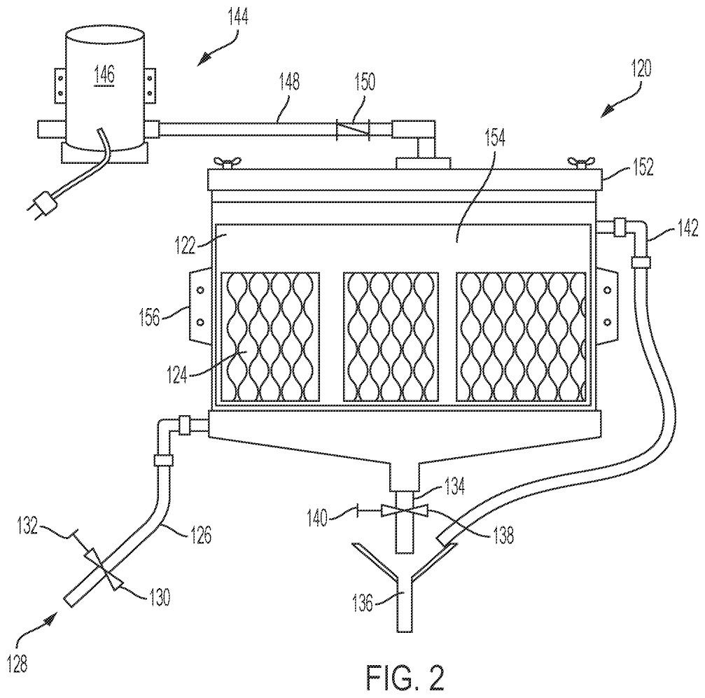

In accordance with the disclosure, there is provided a system 120 for monitoring the integrity such media pads 104 within such an adiabatic cooling system 100. An exemplary such system 120 is illustrated in FIG. 2. The system 120 includes at least one media compartment 122 in which at least one media coupon 124 is disposed. The media coupon 124 is representative of at least one of said media pads 104 within the adiabatic cooling system 100. In the illustrated embodiment, three such media coupons 124 are provided in the compartment 122. It will be appreciated, however, that three such media compartments 122 could be provided, each housing a single media coupon 124, or multiple media compartments 122 may be provided with one or multiple media coupons 124. Those of skill in the art will appreciate that the media coupons 124 may, for example, be constructed on site from media pads 104 utilized in the adiabatic cooling system 100, if desired.

The system 120 further includes at least a first conduit 126 fluidly coupled to the media compartment 122. The first conduit 126 is further is adapted to be fluidly coupled to a source of representative process water (indicated generally as 128), as, for example, the adiabatic cooling system 100 or a tank (not illustrated). The representative process water is representative of process water 106 within the circulation system 108 of the adiabatic cooling system 100. In this way, the first conduit 126 is may be fluidly coupled to provide the representative process water to said at least one media compartment 122. The first conduit 126 may be provided with a valve 130 that controls the flow of representative process water through the first conduit 126 to the media compartment 122. In at least one embodiment, valve 130 may be provided with a timer (indicated generally as 132), which may control, for example, the time for which the valve 130 is open to supply representative process water, as well as the timing as to when the valve 130 opens. In at least one embodiment, the valve 130 and/or timer 132 may be controlled by a controller (not illustrated).

The system 120 may further be provided with a second conduit 134 disposed to drain the compartment 122 to a drain 136, for example. The second conduit 134 may likewise be provided with a valve 138, as well as a timer 140. As with the first conduit 126, in at least one embodiment, the valve 138 and/or timer 140 may be controlled by a controller (not illustrated).

The system 120 may further be provided with a third conduit 142. In the illustrated embodiment, the third conduit 142 is provided as a safety measure, and is disposed drain any overflow of representative process water from the media compartment 122 in the event that the representative process water reaches the top portion of the media compartment 122. If provided, the third conduit 142 may direct such an overflow to drain 136, or another appropriate tank or the like.

In order further simulate the adiabatic cooling system 100, the system 120 further includes a source of airflow 144 which is likewise fluidly coupled to the at least one media compartment 122. The source of airflow 144 may be any appropriate source. For example, the source of airflow 144 may be an air dryer 146, such as illustrated, or one or more fans that either push or pull air through the media coupon 124. In the illustrated embodiment, a fourth conduit 148 connects the source of airflow 144 to the media compartment 122. A check valve 150 may be provided in the conduit 148 to ensure that airflow is directed toward the compartment 122. Such a check valve 150 may inhibit the flow of representative process water from the media compartment 122 from backing up through the conduit 148 in the event of a malfunction or the like.

Those of skill in the art will appreciate that the provisions of a flow of representative process water and an airflow to the at least one media compartment 122 may simulate in the media coupon 124 the operation and weathering of the media pad 104 in the adiabatic cooling system 100. The media coupon 124 may be analyzed as representative of media pads 104 within the adiabatic cooling system 100. The media coupon 124 may be removed from the media compartment 122 for testing or destruction, for example, by removing a portion 152 of the media compartment 122. In at least one embodiment, the at least one media compartment 122 includes at least one transparent wall 154 such that the media coupon 124 may likewise be viewed during the provision of representative process water and airflow.

Those of skill in the art will further appreciate that in arrangements of the system 120 utilizing a plurality of media coupons 124, the media coupons 124 may be exposed to the flow of representative process water and an airflow for varied periods of time. In this way, for example, a first media coupon 124 may be removed for testing while other media coupons 124 remain exposed to the flow of representative process water and an airflow.

The system 120 may be a freestanding unit, or may be fluidly coupled with the adiabatic cooling system 100. In the embodiment of FIG. 2, for example, the system 120 may be secured to or near the adiabatic cooling system 100 with one or more flanges 156 or other mounting arrangement.

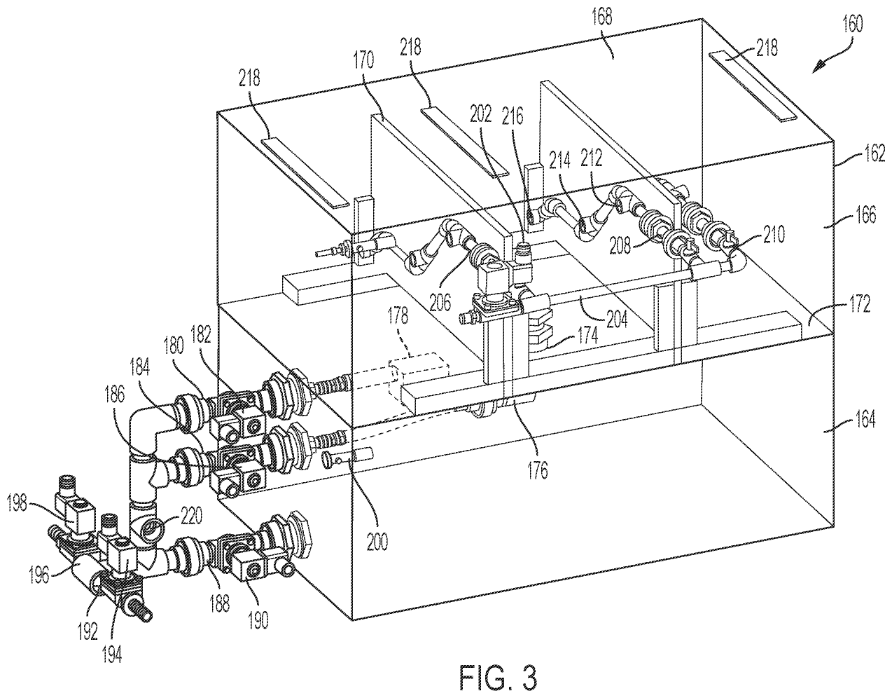

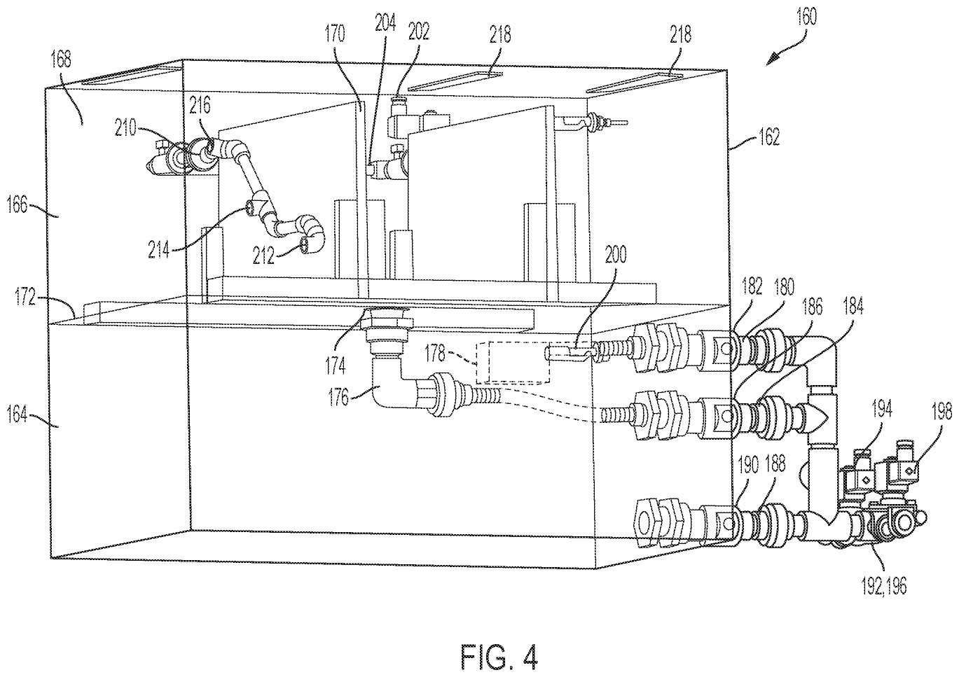

An alternative embodiment of the system 160 for monitoring the integrity of media pads is illustrated in FIGS. 3 and 4. In this embodiment, a housing 162 includes a holding tank 164 for holding representative process water, and a media tank 166 in which media coupons (not illustrated) are supported. The media tank 166 may be configured to provide three individual media compartments 168 for containing three media coupons (not illustrated). In this embodiment, however, partitions 170 between the individual media compartments 168 are removable such that the media tank 166 may be configured to provide one or two media compartments 168 by removal of both or one of the partitions 170. It will be appreciated that the removable partitions 170 not only provide flexibility in the configuration of one or more individual compartments 168; they also provide flexibility to accommodate different sizes of media coupons. In this embodiment, the partitions 170 are spaced from a bottom surface 172 of the media tank 166 such that representative process water may flow to each of the media compartments 168.

Representative process water may be provided to and/or removed from the media tank 166 through a drain/fill port 174. A conduit 176 may provide fluid communication between the port 174 and a pump (identified generally as 178). In order to provide representative process water to and drain water from the holding tank 164 and/or the media tank 166, one or more conduits may be provided. By way of example, a first conduit 180 may be provided and fluidly coupled directly to the pump 178. Flow through the first conduit 180 may be regulated by a first solenoid valve 182. A second conduit 184, flow through which is controlled by a second solenoid valve 186, may be provided to provide direct drain and fill of the media tank 166. A third conduit 188, flow through which is controlled by a third solenoid valve 190, may be provided to drain and/or fill the holding tank 164. Representative process water may be provided to or drained from one or more of the conduits 180, 184, 188 by way of one or more conduits. For example, connecting conduit 192 controlled by solenoid valve 194 may be fluidly coupled to a source of representative process water, such as an adiabatic cooling system 100 or a tank (not shown), while connecting conduit 196 controlled by solenoid valve 198 may be fluidly coupled to a drain (not shown).

Additional fluid controls may be provided. For example, the holding tank 164 may be provided with a float switch 200 configured to control the operation of one or more of the solenoid valves 182, 186, 190, 194, 198, or to provide a signal to a controller configured to control the solenoid valves 182, 186, 190, 194, 198.

In order further simulate the adiabatic cooling system 100, the system 160 further includes a source of airflow (indicated generally as 202) which is likewise fluidly coupled to the at least one media compartment 168. In the embodiment of FIGS. 3 and 4, conduit 204 connects the source of airflow 202 to individual conduits 206, 208, 210 within each of the media compartments 168. The individual conduits 206, 208, 210 may include a plurality of conduit outlets 212, 214, 216, such as illustrated here, or a single conduit outlet. In order to allow air to escape the media compartments 168 after being pushed through the media coupon, the top wall of the media tank 166 may include one or more tank air outlets 218. In the illustrated embodiment, a respective tank air outlet 218 is provided for each of media compartments 168. It will be appreciated, however, that a single or additional tank air outlets 218 may be provided.

The system 120, 160 may further include one or more sensors. The illustrated embodiment includes a conductivity and temperature sensor 220. It will be appreciated, however, that additional conductivity and temperature sensor, as well as additional sensors may be provided, such as pressure sensors, humidity sensors, and turbidity sensors. It will further be appreciated that such sensors maybe provided in either or both of conduits leading to and/or from the media compartment(s) 168, the media tank 166, and/or the holding tank 164.

### INDUSTRIAL APPLICABILITY

It will further be appreciated that the system 120, 160 provides a method of evaluating the integrity of media pads 104 within an adiabatic cooling system 100 including process water within a circulation system 108. A flow of representative process water is provided from the adiabatic cooling system 100 through at least a first conduit system to at least one media compartment 122, 168 containing at least one media coupon 124 that is representative of at least one of the media pads 104 within the adiabatic cooling system 100. This flow simulates the flow of process water to media pads 104 within the adiabatic cooling system 100. The system 120, 160 further provides a flow of air to the at least one media compartment 122, 168 to simulate the flow of air to media pads 104 within the adiabatic cooling system 100. When provided, the media coupons 124 may be observed through a transparent section 154 of the media compartment 122, 168. Unlike the media pads 104 of the adiabatic cooling system 100, the media coupons 124 may be readily removed from the media compartment 122, 168, and then analyzed. In this way, the media coupons 124 are representative of the media pads 104 within the adiabatic cooling system 100.

In some adiabatic cooling systems 100, the media pads 104 104 are saturated and then dried each day. Accordingly, in at least one embodiment, the flow of representative process water saturates the at least one media coupon 124, and the representative process water is then drained from the media compartment 122, 168. The flow of air then dries out the at least one media coupon 124. This saturation and drying of the media coupon 124 simulates a cycle of the saturation and drying of media pads 104 in an adiabatic cooling system 100. Multiple cycles of saturation and drying may be performed in order to simulate a specified period of time, such as a specified number of days in an adiabatic cooling system 100. In this way, the system 120, 160 may be utilized to predict when the media pads 104 104 of the adiabatic cooling system 100 are likely to fail, or to need replacement. When multiple media coupons 124 are utilized, the media coupons 124 may be subjected to different numbers of saturation and drying cycles in order to simulate different periods of time within the adiabatic cooling system 100.

In at least one embodiment, a flow of representative process water from the adiabatic cooling system 100 is provided to at least one media compartment 122, 168 containing at least one media coupon 124 and a flow of air is provided to the at least one media compartment 122, 168 in a manner and schedule that is similar to the adiabatic cooling system 100. For example, if a portion of the media pads 104 of the adiabatic cooling system 100 are partially submerged in process water, while air to be cooled is provided to the media pads 104, a portion of the media coupon 124 may likewise be partially submerged in representative process water while air to be cooled is provided to the media coupon 124. In this way, the system 120, 160 may be utilized to simulate continuous operation of an adiabatic cooling system 100.

According to another feature of this disclosure, the system 120, 160 may be utilized to evaluate the integrity of media pads 104 of an adiabatic system 100 over different periods of operation. In utilizing at least two media coupons 124, the steps of removing and analyzing the coupons 124 may be performed after different periods of time. In this way, one of the media coupons 124 may be removed, tested, and even destroyed, while the other or others continue to be exposed to the simulation.

According to another feature of this disclosure, various aspects of the system 120, 160 may be monitored and considered in evaluating both the system 120, 160 and the integrity of the media coupons 124. For example, a plurality of sensors 220 may be provided to sense water temperature, air temperature, pressure, humidity, turbidity, and conductivity.

It will thus be appreciated that the systems 120, 160 disclosed herein may be used to evaluate the integrity of media pads 104 utilized in an adiabatic cooling system 100. In this way, utilization of the system 120, 160 may extend not only the life of media pads 104 in an adiabatic cooling system 100, but also the life the adiabatic cooling system 100 itself.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A system for evaluating the integrity of media pads within an adiabatic cooling system including process water within a circulation system, the system for evaluating comprising:
at least one media compartment;
at least one media coupon disposed within said media compartment, the media coupon being representative of at least one of said media pads within the adiabatic cooling system;
at least a first conduit, the first conduit adapted to be fluidly coupled to a source of representative process water, said representative process water being representative of process water within the circulation system, the first conduit being fluidly coupled to provide said representative process water to said at least one media compartment;
a source of airflow fluidly coupled to the at least one media compartment;
such that a flow of representative process water and an airflow are provided to the at least one media compartment to simulate said adiabatic cooling system;
whereby the at least one media coupon may be analyzed as representative of media pads within the adiabatic cooling system.

2. The system for evaluating the integrity of media pads as claimed in claim 1 wherein said at least one media compartment includes at least one transparent wall whereby the at least one media coupon may be viewed through the at least one transparent wall.

3. The system for evaluating the integrity of media pads as claimed in claim 1 including at least three media coupons.

4. The system for evaluating the integrity of media pads as claimed in claim 3 including at least three media compartments, wherein the at least three media coupons are disposed in said at least three media compartments, respectively.

5. The system for evaluating the integrity of media pads as claimed in claim 4 wherein said at least three media compartments are exposed to at least one of different number of cycles of the flow of representative process water and airflow, and different time periods of exposure to the flow of representative process water.

6. The system for evaluating the integrity of media pads as claimed in claim 1 further including a plurality of sensors, said plurality of sensors including at least two sensors of a group of sensors including temperature sensors, pressure sensors, humidity sensors, turbidity sensors, and conductivity sensors.

7. The system for evaluating the integrity of media pads as claimed in claim 1 wherein the at least one media coupon is removable.

8. The system for evaluating the integrity of media pads as claimed in claim 1 wherein the source of process water includes a holding tank, and the first conduit includes a port between the holding tank and the at least one media compartment.

9. The system for evaluating the integrity of media pads as claimed in claim 8 further including at least one conduit fluidly coupling the holding tank to at least one of the adiabatic cooling system, a source of fresh water, and a source of other fluid.

10. The system for evaluating the integrity of media pads as claimed in claim 1 further including at least one valve.

11. The system for evaluating the integrity of media pads as claimed in claim 10 wherein the at least one valve is disposed in at least one of the first conduit and at least a second conduit fluidly coupled to the at least one compartment to drain said process water.

12. The system for evaluating the integrity of media pads as claimed in claim 11 further including at least one timer, and wherein the at least one timer is adapted to control opening and closing of the at least one valve.

13. The system for evaluating the integrity of media pads as claimed in claim 1 further including a pump configured to pump said representative process water from the source of process water to the at least one media compartment.

14. A method of evaluating the integrity of media pads within an adiabatic cooling system including process water within a circulation system, the method comprising:
providing a flow of representative process water from the adiabatic cooling system through at least a first conduit system to at least one media compartment containing at least one media coupon to simulate the flow of process water to media pads within the adiabatic cooling system, the at least one media coupon being representative of at least one of said media pads within the adiabatic cooling system;
providing a flow of air to the at least one media compartment to simulate the flow of air to media pads within the adiabatic cooling system;
removing the at least one media coupon; and
analyzing the at least one media coupon as representative of media pads within the adiabatic cooling system.

15. The method of evaluating the integrity of media pads as claimed in claim 14, wherein
providing the flow of representative process water from the adiabatic cooling system through at least a first conduit system to at least one media compartment includes saturating the at least one media coupon; and
providing the flow of air to the at least one media compartment includes drying out the at least one media coupon;
wherein providing the flow of representative process water to saturate and providing the flow of air to dry out at least one media coupon simulates a specified period of time of operation of the adiabatic cooling system;
the method further including repeating the simulation of the specified period of time of operation of the adiabatic cooling system at least once.

16. The method of evaluating the integrity of media pads as claimed in claim 15 wherein simulating a specified period of time of operation of the adiabatic cooling system includes providing the flow of representative process water to a plurality of media coupons and providing a flow of air to the plurality of media coupons, and repeating the simulation of a specified period of time of operation of the adiabatic cooling system includes repeating the step of simulating the specified period of time of operation of the adiabatic cooling system a different number of times for at least two of said media coupons prior to the steps of removing the at least one media coupons and analyzing said at least two media coupons.

17. The method of evaluating the integrity of media pads as claimed in claim 14 wherein providing a flow of representative process water from the adiabatic cooling system to at least one media compartment containing at least one media coupon and providing a flow of air to the at least one media compartment are applied in a manner and schedule similar to the adiabatic cooling system.

18. The method of evaluating the integrity of media pads as claimed in claim 14 wherein providing a flow of representative process water from the adiabatic cooling system to at least one media compartment containing at least one media coupon and providing a flow of air to the at least one media compartment are applied in a manner similar to the adiabatic cooling system with continuous operation.

19. The method of evaluating the integrity of media pads as claimed of claim 18 including at least two media coupons, and the steps of removing and analyzing are performed after different periods of time for the at least two media coupons.

20. The method of evaluating the integrity of media pads as claimed in claim 14 further including viewing the at least one media coupon through at least one transparent wall of the said at least one media compartment.

21. The method of evaluating the integrity of media pads as claimed in claim 14 further including sensing at least two of water temperature, air temperature, pressure, humidity, turbidity, and conductivity.

22. The method of evaluating the integrity of media pads as claimed in claim 14 wherein providing a flow of process water from the adiabatic cooling system to the at least one media compartment included providing a flow of process water from a holding tank.

23. The method of evaluating the integrity of media pads as claimed in claim 14 further including fluidly coupling the at least one media compartment to the adiabatic cooling system.

24. The method of evaluating the integrity of media pads as claimed in claim 14 further including draining said representative process water from the at least one compartment.
